(19) United States
(12) Patent Application Publication
(10) Pub. No.: US 2017/0368789 A1
(43) Pub. Date: Dec. 28, 2017

(54) COMPOSITE PANEL AND METHOD FOR MAKING COMPOSITE PANEL

(71) Applicant: R.A. Investment Management S.A.R.L., Luxembourg (LU)

(72) Inventor: Winston MacKelvie, Quebec (CA)

(73) Assignee: R.A. Investment Management S.A.R.L., Luxembourg (LU)

(21) Appl. No.: 15/538,485

(22) PCT Filed: Dec. 11, 2015
(86) PCT No.: PCT/IB2015/059561

§ 371 Date: Jun. 21, 2017

Related U.S. Application Data
(63) Continuation of application No. 14/580,333, filed on Dec. 23, 2014.

(51) Int. Cl. B32B 3/30; B32B 3/06; B32B 3/12; B32B 3/26; B32B 37/18; B32B 3/28; B32B 15/04; B29D 99/00; B32B 15/08; B32B 37/04; B32B 3/02; B32B 37/08; B32B 37/10; B32B 37/14; B32B 37/20; B32B 38/00

(52) U.S. Cl. CPC B32B 3/30; B32B 3/02; B32B 3/06; B32B 3/12; B32B 3/26; B32B 3/263; B32B 37/182; B32B 3/28; B32B 15/04; B29D 99/0021; B32B 15/08; B32B 37/04; B32B 3/266; B32B 15/043; B32B 37/08; B32B 37/10; B32B 37/1027; B32B 37/14; B32B 37/203; B32B 38/0012; B32B 2250/03; B32B 2250/40; B32B 2311/00; B32B 2419/00; B32B 2607/00; B32B 2605/00

(57) ABSTRACT

A composite panel includes a core having at least one core element. The core element includes a shell defining a cavity. A pair of skins sandwich the core. Each skin has a first face facing away from the core and an opposed second face facing the core. The second face has a plurality of barbs extending therefrom. The barbs penetrate the shell to secure the core element between the skins. A method for making a composite panel includes positioning a core element against a barbed face of a first skin, where the core element includes a shell defining a cavity, and pressing the core element and first skin together to force barbs of the barbed face to penetrate the shell.

### CROSS-REFERENCES TO RELATED APPLICATIONS

This application claims the benefit of U.S. patent application Ser. No. 14/580,333, filed Dec. 23, 2014, the entirety of which is incorporated herein by reference.

### FIELD

The disclosure relates to panels, for example structural panels or other panels that may be used in the construction industry. More particularly, the disclosure relates to composite panels and methods for making composite panels.

### BACKGROUND

U.S. Pat. No. 8,490,355 purports to disclose a ventilated structural panel comprising a first sheet having edges that define a horizontal axis with a first horizontal edge and a second horizontal edge, and a vertical axis with a first vertical edge and a second vertical edge. A second sheet of substantially the same planar dimensions as the first sheet has edges that define a horizontal axis and vertical axis, with a first horizontal edge and a second horizontal edge and a first vertical edge and a second vertical edge. The first and second sheet are parallel in plane and matched in at least one of the vertical axis and the horizontal axis. A plurality of spacing structural elements fixedly attach the first sheet to the second sheet, such that the yield strength of the combined panel is greater than the combined individual yield strengths of the first and the second sheet. The plurality of spacing structural elements are arranged such that a plurality of unobstructed pathways are created for air to move from at least one edge of the panel to at least one of an opposite and an adjacent edge of the panel, and are arranged to provide integral ventilation through the materials and between the first and the second sheet.

### SUMMARY

The following summary is intended to introduce the reader to various aspects of the disclosure, but not to define or delimit any invention.

Composite panels as disclosed herein may in some examples include skins of sheet material (such as plastic, metal or wood), which may be relatively thin, and which sandwich a core (which may be or may include honeycomb board, hard foam, formed ribs, and corrugate, etc.), which may be relatively thick.

In some examples, the further apart the skins, the stiffer the resulting composite panel.

According to some aspects, a composite panel includes a core and two skins. The core includes at least one core element, and each core element has a hollow interior region. Each skin has one face textured with barbs. The core is sandwiched between the skins so that multiple barbs on each skin penetrate into each core element.

The core element(s) may be made of or may include a thermoplastic material. The composite panel may then be formed by heating and pressing each skin against the core element(s) to cause the barbs to penetrate the core elements so that when the heat is removed, the thermoplastic material solidifies around the penetrating barbs to lock the skins and core together.

Each skin may be a sheet of metal with pointed barbs, with the two skins substantially parallel to each other. Alternatively, the skins may be non-parallel.

The core may include multiple similarly shaped core elements, or multiple differently shaped core elements, or only a single core element.

One or more of the core elements may be tube shaped (i.e. tubular), or all of the core elements may be tube shaped. One or more of the core elements may be spherical, or all of the core elements may be spherical. One or more of the core elements may have a rectangular or trapezoidal cross-section.

The core may be or may include a dimpled thermoplastic sheet, and each dimple may serve as a core element.

The core may be or may include a corrugated plastic sheet, and each peak or each trough of the corrugated plastic sheet may serve as a core element.

Each skin may be a sheet of metal with pointed barbs having pointed ends (or tips). One or more of the pointed barbs may penetrate fully through a wall (or shell) of each core element in the hollow interior region (or cavity), and may be clinched.

Each core element may be tube shaped. The pointed ends of the barbs may then be clinched by drawing a plug through each core element.

The composite panel may include first and second cores, first and second outer skins, and one inner skin. Each core element may have a hollow interior region (or cavity). The first and second outer skins may have one face textured with barbs, and the inner skin may have two faces textured with barbs. The first core may then be sandwiched between the first outer skin and the inner skin so that one or more of barbs on each of the first outer skin and the inner skin penetrate into each core element in the first core. The second core may be sandwiched between the second outer skin and the inner skin so that one or more of barbs on each of the second outer skin and the inner skin penetrate into each core element in the second core.

According to some aspects, a process for making a composite panel employs a core with at least one core element having a hollow interior region, and first and second skins, each skin having one face textured with barbs. The textured face of the first skin may be brought into contact with the core. The first skin and core may then be pressed together to cause at least one of the barbs to penetrate each core element. The textured face of the second skin may also be brought into contact with the core (before, after or at the same time that the first skin is brought into contact with the core) and the second skin and core may then be pressed together to cause at least one of the barbs to penetrate each core element (before, after or at the same time that the first skin and core are pressed together).

In this process, the core elements may be made of a thermoplastic material. The steps of bringing the textured face of the first skin into contact with the core and bringing the textured face of the second skin into contact with the core may each also include heating the skin so that the barbs are sufficiently hot to cause the thermoplastic material to at least partially melt where contacted by the barbs, so that when the barbs have penetrated the core elements and the heat is removed, the thermoplastic solidifies around the penetrating barbs to lock the skins and core together.

According to some aspects, a composite panel includes a core having at least one core element. The core element includes a shell defining a cavity. A pair of skins sandwich the core. Each skin has a first face facing away from the core and an opposed second face facing the core. The second face has a plurality of barbs extending therefrom. The barbs penetrate the shell to secure the core element between the skins.

Each barb may have a tip, and the barbs may extend through the shell so that the tips are within the cavity. The tips may be clinched.

The core element may be a thermoplastic core element.

Each skin may be or may include a metal sheet.

The shell may be an elongate member having a first end and a second end. The cavity may be open at the first end and the second end. The core element may be tubular.

The core may include a plurality of core elements.

The core may include at least one of a corrugated sheet and a dimpled sheet.

The cavity may be open to the environment.

The composite panel may further include a filler in the cavity.

According to some aspects, a method for making a composite panel includes positioning a core element against a barbed face of a first skin. The core element includes a shell defining a cavity. The method further includes pressing the core element and first skin together to force barbs of the barbed face to penetrate the shell.

The shell may be made from a thermoplastic material, and the method may further include, prior to or during step b), applying heat to the shell to soften the shell. The method may include heating the first skin, wherein heat is applied to the shell via the first skin. The method may further include, after step b), cooling the shell to harden the shell and securely embed the barbs in the shell.

The method of may further include positioning the core element against a barbed face of a second skin, and pressing the core element and the second skin together to force barbs of the barbed face of the second skin to penetrate the shell.

Step b) may include pressing the core element and first skin together so that tips of at least some of the barbs pass through the shell and into the cavity. The method may further include clinching the tips. Clinching the tips may include passing a plug into the cavity and contacting the tips with the plug to bend the tips.

The method may further include filling the cavity with a filler.

### BRIEF DESCRIPTION OF THE DRAWINGS

The drawings included herewith are for illustrating various examples of articles, methods, and apparatuses of the present disclosure and are not intended to limit the scope of what is taught in any way.

In the figures, a symbol containing the letter “F” surrounded by wavy lines is used to indicate that the adjacent surface is heated.

In the drawings:

FIG. 1 is a perspective view of an example skin showing four barbs with four different shapes: pointed, headed, hooked, and curved;

FIG. 2a is a perspective view of another example skin, showing parallel rows of spaced barbs;

FIG. 2 is a cross-section taken along line 2-2 in FIG. 2, showing a single row of pointed barbs;

FIG. 3a is an end view of another example skin, in the form of a piece of sheet material with a row of barbs on each face of the sheet;

FIG. 3 is a cross-section taken along line 3-3 in FIG. 3a, showing how a pressure plate may be used to form headed barbs on the lower face of the sheet by deforming the tips of pointed barbs;

FIG. 4a is a schematic end view showing an example tubular core element resting on the barbs of an example skin in the form of a piece of barbed sheet material, with an example channel shaped pressure plate urging the core element and skin together;

FIG. 4b is a schematic end view showing the core element and skin of FIG. 4a, where the pressure plate walls have come to rest on a support surface, and the core element's melt plane has engulfed the contacting barbs;

FIG. 4c is a schematic end view showing the core element and skin of FIG. 4a, where the core element and skin have been inverted onto a second skin, a pressure shim removed, and the core element melt plane engulfing the barbs of the second skin;

FIG. 4d is a schematic end view showing an example auxiliary layer of material being sandwiched between the core element and skin of FIG. 4c, so as to meld with the barbs into the core element;

FIG. 4e is an enlarged view of the elements depicted in FIG. 4d, after the melding of the core element, auxiliary layer and barbs;

FIG. 4f is a schematic end view illustrating an example process where a support plate on the left is heated and a support plate on the right is cold, whereby the assembly on the heated plate is slid onto the cold plate while maintaining pressure, and is held there until the shell of the core element re-solidifies;

FIG. 5 is a partial end view of an example composite panel, showing a core including a side-by-side arrangement of core elements (tubes), connected to heated skins by barbs that have melted into and penetrated the shell (or wall) of the core elements;

FIG. 6 is a longitudinal cross-section taken through the composite panel of FIG. 6, showing one skin with barbs that have been post-shaped (i.e. clinched) by pulling a plug through the cavity of the core element so as to bend or rivet (i.e. clinch) over the tips of barbs;

FIG. 7 is a perspective view of another example composite panel, including three skins and two cores (the top skin is not shown for clarity), where the core elements of one layer are at approximately a right angle relative to the core elements of the other layer, and also showing how core element ends may be sealed closed, filled with filler such as foam, and/or have an air fitting, and where the core elements can be being used as conduits for fluid flow or for utility items such as wire or pipe;

FIG. 8 is a cross-section taken through another example composite panel, including non-round core elements, where some core elements are spaced apart;

FIG. 9 is a perspective view of an example dimpled thermoplastic sheet that can serve as or in a core or core element in a composite panel;

FIG. 10 is an end view of an example composite panel including the dimpled thermoplastic sheet of FIG. 9 as a core, sandwiched between a pair of skins, and showing heat being applied from above and below to secure the skins to the core;

FIG. 11 is a perspective view of the composite panel of FIG. 10;

FIG. 12 is a cutaway perspective view of another example composite panel, including hollow thermoplastic spheres or balls serving as core elements;

FIG. 13 is a perspective view of an example core element in the form of a short tube with sealed ends;

FIG. 14 is a schematic top view of another example composite panel, with the top skin not shown, including multiple arrangements of core elements in the form of tubes;

FIG. 15 is a schematic top view of an example skin, with strips and patches of auxiliary material applied thereto, at locations where core elements are to make contact;

FIG. 16 is a schematic end view showing an example first step of a process for the formation of an example corner composite panel, where the skins are pre-bent to receive tubular core elements, and a formed pressure plate is shown urging the core elements onto the barbs of a heated outer skin;

FIG. 17 is a schematic end view showing a next step in the process of FIG. 16, where the pressure plate is heated to urge the inner skin towards the core elements, completing the corner composite panel;

FIG. 18 is an end view showing the corner composite panel of FIG. 17, and also showing an example end treatment whereby an adjacent panel is inter-locked to the corner composite panel and the joint adhesively filled, locking the engaged barbs together;

FIG. 19 is an end view of another example composite panel, where the skins have tapered flanges, and which includes tubular core elements of differing diameters, including solid core elements at the ends with threaded fasteners;

FIG. 20 is a schematic end view showing an example step in the formation of another example composite panel, showing tubular and spherical core elements irregularly arranged on a skin, and then being moved under pressure laterally and vertically into their final position as the hot barbs melt their way into and penetrate the shell of the core elements;

FIG. 21 shows an example next step in the formation of the composite panel of FIG. 20, with the upper skin heated and pressed towards the core elements, completing the composite panel fabrication;

FIG. 22 is an end view of another example composite panel including tubular core elements of different diameters, used to create a composite panel having a taper;

FIG. 23 is an end view of another example composite panel having a taper, where the outer tubular core elements are of an oval shape;

FIG. 24 is a schematic end view showing an example method for forming another example composite panel, made with a one-piece core of corrugated plastic commonly referred to as Coroplast™;

FIG. 25 is a schematic end view showing an example method for forming another example composite panel, made with a one-piece core of a corrugated shape having flat peaks, which may facilitate engagement to more barbs than would a shape having pointed peaks;

FIG. 26 is an end view of the composite panel of FIG. 25;

FIG. 27 is a schematic end view showing an example method for forming another example composite panel, where auxiliary strips are sandwiched between the tubular core elements and skins;

FIG. 28 is a schematic side view of an example continuous production process for making composite panels, using coils of textured sheet metal for the skins and a coil of material for the core, where all three components are layered and enter a heating station on a sandwich-style metal belt conveyor that also applies compressive force, followed by a cooling section also under pressure, and a cut-off station where individual panels are severed;

FIG. 29 is a schematic enlarged end view showing how tubular core elements can be joined together, for example for storing in a coil similar to the coil of material of FIG. 28;

FIG. 30 is a schematic side view of another example continuous production process for making a composite panels, in which hollow spherical core elements and skins are continuously assembled into composite panels using the heat-pressure-cool-pressure technique depicted in FIG. 28;

FIG. 31 is a perspective view of three different example core elements that can be used on edge between skins (not shown) in a composite panel; and

FIG. 32 is a perspective view of an example composite panel including the tubular stub core element of FIG. 31, sandwiched between a pair of skins.

### DETAILED DESCRIPTION

Various apparatuses or processes will be described below to provide an example of an embodiment of the claimed subject matter. No embodiment described below limits any claim and any claim may cover processes or apparatuses that differ from those described below. The claims are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Composite panels are disclosed herein. The composite panels may be used in the construction industry, for example as structural panels. In some examples, the composite panels may be used as wall panels, as flooring panels, or as ceiling panels.

In some examples, the composite panels generally include a pair of skins (i.e. two skins) and a core sandwiched between the skins. Barbs of the skins may engage the core to secure the skins and the core together. In some examples, the composite panels may include additional skins and additional cores, so that a multi-layer composite panel is formed. In some examples, the pair of skins may be formed from a single sheet of material, for example a single sheet of material that has been folded to provide two sections that may sandwich a core.

The skins may in some examples be textured sheet material characterized by a “forest” of small, raised barbs on one or both faces of the sheet. More specifically, each skin may have a first face facing away from the core, and an opposed second face facing the core. The second face may have a plurality of barbs (also called a ‘forest’ of barbs) extending therefrom, and may also be referred to herein as a ‘barbed face’. The forest of barbs may resemble Velcro™ hooks. The skins may be sheet metal, such as steel.

The core of the composite panel may include one or more core elements. In some examples, each core element may include a shell defining a cavity. For example, a core element may in the form of a tube, having an outer cylindrical wall forming the shell and defining a generally cylindrical interior cavity. Such core elements may also be described as ‘hollow’. As used herein, the term ‘hollow’ refers to a structure having an interior cavity, even if that interior cavity is ultimately filled. For example, the term ‘hollow’ may be used to describe a tube, whether the interior cavity of the tube is filled with filler such as foam, or is empty.

The shells of the core elements may be relatively thick walled, or relatively thin walled. For example, a shell may have a wall thickness that is greater than a height of the barbs of the adjacent skin. Alternatively, a shell may have a wall thickness that is less than a height of the barbs of the adjacent skin. Furthermore, a shell may have a wall thickness that is greater than a diameter or width of the cavity which it defines. Alternatively, a shell may have a wall thickness that is less than a diameter or width of the cavity which it defines.

The core elements may be made from a thermoplastic material. As used herein, the term ‘thermoplastic material’ refers to a material that becomes pliable or moldable above a certain temperature, and solidifies upon cooling. Examples of thermoplastic materials include, but are not limited to, Nylon™ polypropylene, and polyethylene. In some examples, the core elements, when cooled to room temperature, may be generally stiff and rigid. The use of a thermoplastic material may allow for the barbs of the skins to penetrate the shell of the core element when the shell is heated.

In some examples, in which the core elements are hollow, the core elements may be in the form of hollow elongate members (such as tubes), spheres, dimples of a dimpled sheet, and/or peaks/troughs of a corrugate. In some examples, the core element may be or may include foam or mesh. In some examples, the core elements may be solid (i.e. not hollow), and may be in the form of rods and/or balls. Solid core elements may be useful in examples where the weight of the composite panel is less of a concern. In some examples, solid core elements may be mixed with hollow core elements. As well, solid core elements can be drilled and threaded to accommodate fasteners between the composite panel and adjacent structures.

In some examples, in order to make a composite panel, the skins and core element(s) are assembled as a sandwich (i.e. with the skins sandwiching the core elements). For example, one or more core elements may be positioned against a barbed face of a first skin, and then against a barbed face of a second skin, so that the skins sandwich the core element. The core element and the skins may be pressed together to force the barbs of the barbed face to penetrate the shell of the core element. During pressing, heat may be applied to the shells to soften the shells. In some examples, heat may be applied to the shells via the skins. For example, the skins may be heated from the outside to heat the barbs, so that the barbs heat and soften the shell upon contact, while the remainder of each core element remains generally cool and rigid. The barbs on the skins melt their way into the shell (or wall) of each core element, so that the barbs penetrate the shell and are embedded in the shell. After the barbs penetrate the shell, the shell may be hardened, for example by cooling, to securely embed the barbs in the shell. When the core elements are cooled and hardened, the barbs are locked into the shell of the core elements, to secure the core elements between the skins. In some examples such composite panels may be considered low-cost, lightweight and stiff.

In some examples, the composite panel may be made in a stepwise fashion. For example, one or more core elements may be placed against a barbed face of a first skin, and pressure and heat may be used to secure the core element and first skin together. Then, the core element(s) may be placed against the barbed face of a second skin, and pressure and heat may be used to secure the core element(s) and second skin together.

In some examples, advantageous properties of the composite panels described herein can include floatability, high thermal and sound insulative properties, the ability to provide built-in conduits, fireproofing or fire resistance, paintability, magnetic attractability, surface weldability, and/or ability to attach to threaded fasteners.

Textured sheet materials suitable for use as skins are available from Nucap Industries Inc. (Toronto, Canada). Some such materials are described in Canadian Patent No. 2,760,923, issued on Mar. 11, 2014, Canadian Patent Application No. 2,778,455, published on Jun. 6, 2013, Canadian Industrial Design Registration No. 145893, registered on Dec. 10, 2013, U.S. Pat. No. 6,843,095, issued on Jan. 18, 2005, U.S. Pat. No. 6,910,255, issued on Jun. 28, 2005, each of which is hereby incorporated into this document by reference.

In some particular examples, a composite panel can include rigid, hollow, thermoplastic core elements assembled and sandwiched between skins of textured metal having raised barbs. In some examples, only the skins are directly heated during production. Pressure may be applied to the skins, causing their barbs to penetrate and melt their way into the thermoplastic material of the core elements. The pathway melted by the barbs displaces a like volume of liquid thermoplastic, which flows back along and under the barbs, which may be hooked or headed, thereby embedding the barb. On cooling, the embedded barbs lock or secure the skins and core together. This can in some examples result in a lightweight, rigid, low-cost, easy to manufacture composite panel.

In some examples, textured sheet metal may be used for the skins, because the barbs may remain stiff at the temperatures and pressures used to form the panels. Steel, aluminum and other metals and materials can be textured with a variety of barb profiles (headed, pointed, hooked, curved), in a range of densities, for example, 200-1300 per square cm (or 30-200 per square inch), and a range of heights, for example, 0.03 to 0.15 cm (or 0.01 to 0.06 inches), and with partial or total coverage of one or both faces of the skin.

Hollow thermoplastic cores or core elements may include or may be, but are not limited to, tubes, spheres, dimpled sheet, and/or corrugate. Being hollow, the core may be, by volume, mostly air, and are therefore relatively lightweight, which can result in a lightweight composite panel.

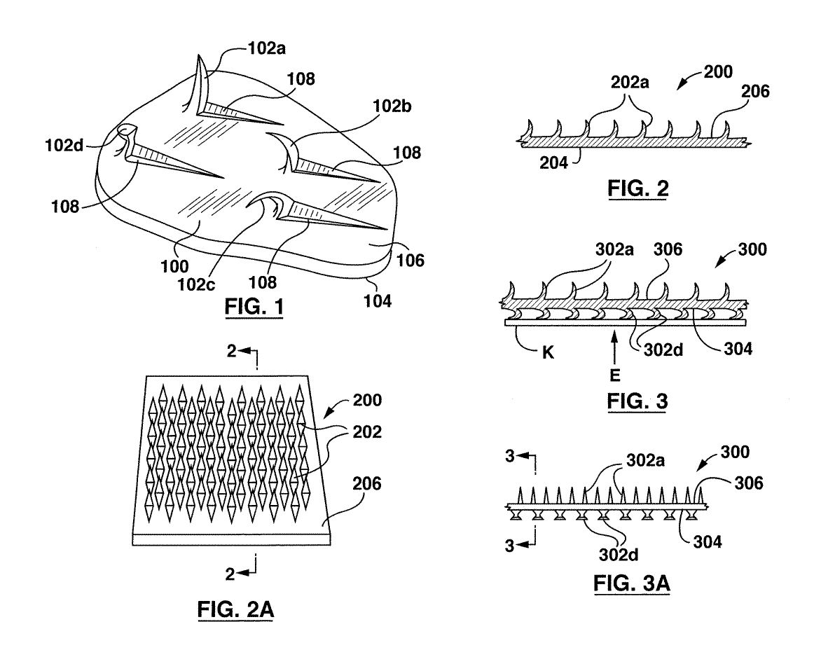

Referring now to the drawings, FIGS. 1 to 3a show example skins (or portions thereof) 100, 200, 300, which may be used in the composite panels disclosed herein. Skin 100 includes four different types of barbs 102a, 102b, 102c, 102d. Skin 200 does not have barbs extending from its first face 204, and does have barbs 202a extending from its opposed second face 206 (i.e. skin 200 is single sided). Skin 300 has barbs 302d extending from its first face 304 and barbs 302a extending from its second face 306 (i.e. has barbs on both faces and is double sided).

FIG. 1 shows the profiles of four example barbs, namely: pointed barb 102a, hooked barb 102b, curved barb 102c, and headed barb 102d. Each profile provides various properties and uses that can depend, for example, on the adjoining material and the method of fabrication used. The barbs 102 may, for example, be carved or ploughed (plowed) up from a groove 108 by the tip of one or more toothed blades (not shown). Different barbs can be formed on either face (i.e. on the first face 104 or the second face 106) and in different places on either face if desired. For example alternating rows of hooked and headed barbs could be formed on a face of a sheet.

FIG. 2 is a cross sectional view through a skin 200, showing a single row of pointed barbs 202a on a second face 206 of the skin 200. FIG. 3 is a cross sectional view through a skin 300 having rows of barbs on both faces (i.e. barbs 302d on first face 304 and barbs 302a on opposed second face 306) and where the formerly pointed barbs on the first face 304 have been partially crushed by a plate K under force E to produce headed barbs 302d. FIG. 2a is a perspective view of the skin 200. FIG. 3a is an end view of skin 300, showing rows of pointed barbs 302a and headed barbs 302d in parallel rows.

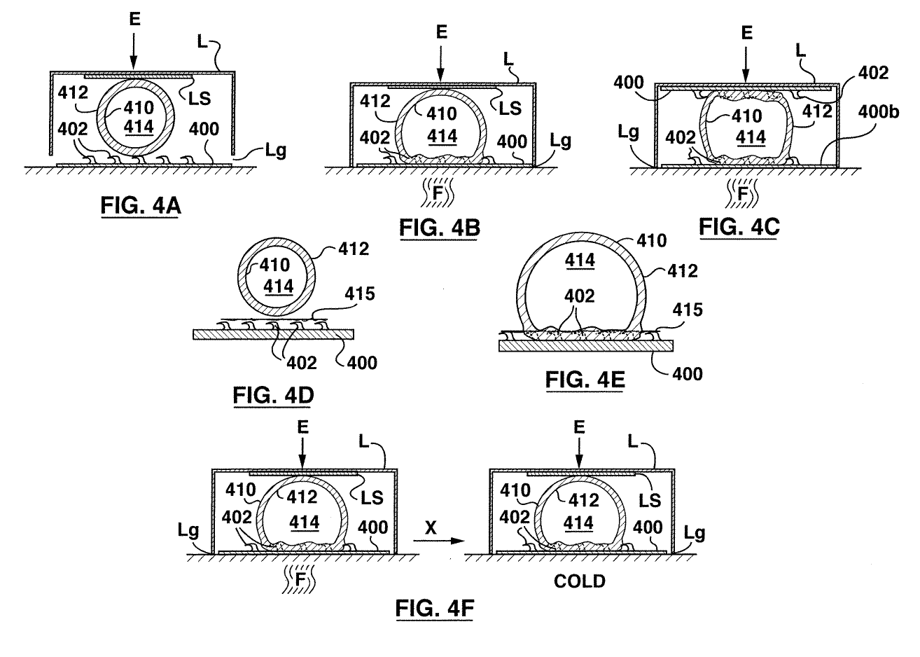

FIGS. 4A through 4E show an example core element 410, which is in the form of a tube, and may also be referred to as a tubular core element 410. The tubular core element 410 has a shell 412 which may be made from or may include a thermoplastic material. The shell 412 defines a cavity 414. In the example shown, the cavity 414 is open to the environment, as the opposed ends of the tubular core element 410 are open. In alternative examples described further below, the cavity may be closed to the environment.

In this example, the core element 410 is shown first resting on the barbs 402 of a skin 400 in FIG. 4a. A pressure plate L in the shape of a channel has side flanges of a length selected to limit downward travel. A shim Ls takes up space equal to the thickness of two skins (excluding barbs). FIG. 4b shows that with heat F and pressure E, pressure plate L forces core element 410 towards the skin 400, so that the heated barbs 402 melt into and penetrate the shell 412 of the core element 410, and create a melt plane which increases until gap Lg closes, thereby preventing further descent. The pressure plate L can also ensure that the top of the core remains parallel to the skin 400.

In FIG. 4C the core element 410 and skin 400 are inverted onto a second skin 400b resting on the heated support plate. The shim Ls is removed and the heat F and pressure E again cause the shell 412 of the core element 410 to be penetrated by the barbs 402 of the second skin 400b and melt over the barbs 402, while the two skins 400, 400b remain parallel.

An alternative example is shown in FIGS. 4D and 4E, in which an auxiliary layer 415 of thermoplastic sheet, film, fabric, or inorganic fibre-fabric, such as fiberglass or steel wool is shown between the skin 400 and core element 410. As the hot barbs 402 penetrate by melting through the film or pushing through the fibre, auxiliary layer 415 becomes entrained into the barbs to add strength or other properties.

FIG. 4F shows, on the left, where the shell 412 of the core element 410 has been penetrated by the barbs 402. As shown with arrow X, the assembly can then be slid onto a cold support plate (optionally still under pressure E) on the right so as to cool the thermoplastic core element 410 and complete the composite panel fabrication.

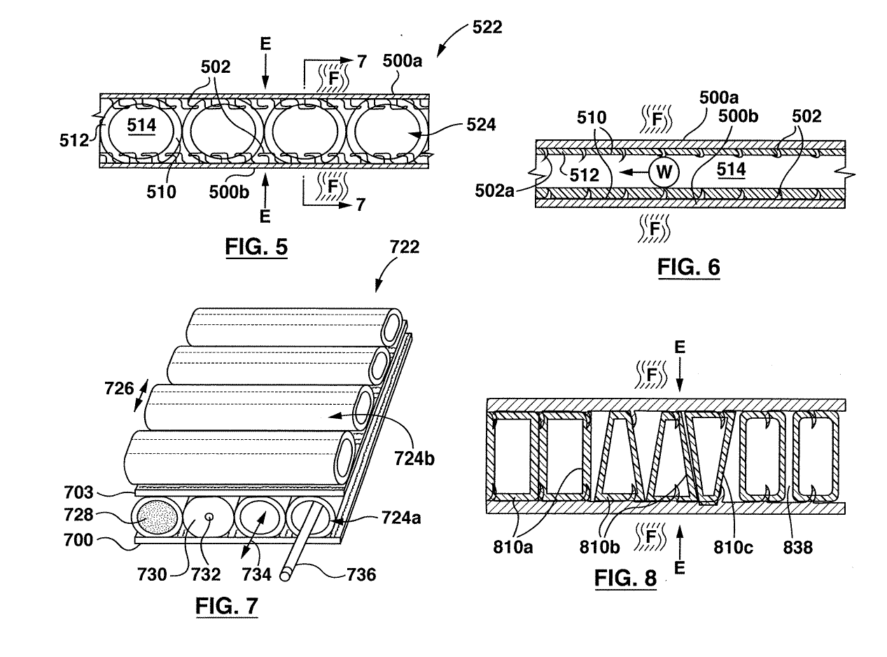

FIG. 5 is an end view of a composite panel 522 that includes a core 524 of tubular core elements 510, each including a shell 512 and a cavity 514, arranged side-by-side and having been simultaneously penetrated by (or melted into) by headed barbs 502 of upper 500a and lower 500b skins using heat F and force E, thereby creating a composite panel 522 whose core is largely air.

FIG. 6 is a cross sectional view showing pointed barbs 502a that have penetrated core element 510. The pointed barbs 502a on the upper skin 500a fully penetrate and extend through the shell 512, such that their tips are within the cavity 514 (i.e. exposed along the interior of the core element 510). In a post-assembly operation, a plug W is drawn through the tube (to the left in FIG. 6) to clinch or rivet over the tips (converting pointed barbs 502a into headed barbs 502) to add anchor strength.

FIG. 7 shows a two layer composite panel 722, which can be fabricated using two outer skins 700 (only the lower one of which is shown), two cores 724a, 724b formed from tubular core elements 710, and a middle third skin 703, which has barbs extending from both faces. The middle third skin 703 separates the two cores 724a, 724b, which are arranged crosswise to promote equalization in panel stiffness in all directions. The upper skin is not shown in FIG. 7 for clarity; however, the melt planes 726 created are between the dotted lines on the tubular core elements 710. In some examples, in the assembly of such a composite panel, the middle skin 703 and core elements 710 can optionally be assembled using induction or microwave energy (or some other non-contact heating means), whereby the core elements 710 remain cool and skin 703 alone is heated. Then, the outer skins 700 can be added using contact heat like contact heat F shown in FIGS. 5 and 6.

Also shown in FIG. 7 is how the use of hollow core elements 710, such as sections of tube, can allow for various materials to be stored in the cavity or pass through the cavity of the core elements 710. Such materials may also be referred to herein as ‘filler’. For example, the core elements 710 can be filled with foam 728, or have the ends plugged 730 and the plug may have a fitting 732 to, for example, pressurize the core element to add stiffness to the core element 710. In addition, the core elements can be used for fluid passage 734 or to act as conduit for wires 736, pipes, cables, etc.

FIG. 8 shows tubular core elements that are non-round in transverse section. These core elements include rectangular tubular core elements 810a and trapezoidal tubular core elements 810b and 810c (where 810b refers to trapezoidal tubular core elements that are upright and 810c refers to trapezoidal tubular core elements that are inverted). Some adjacent trapezoidal tubular core elements (i.e. the two elements labeled 810b) are in the same orientation (e.g. both upright), and some adjacent trapezoidal tubular core elements (i.e. the adjacent elements labeled 810b and 810c) are in opposite orientations (i.e. one inverted) so that they are nested. A space 838 can optionally be left between core elements to lower the number of core elements in a given composite panel and therefore decrease panel weight.

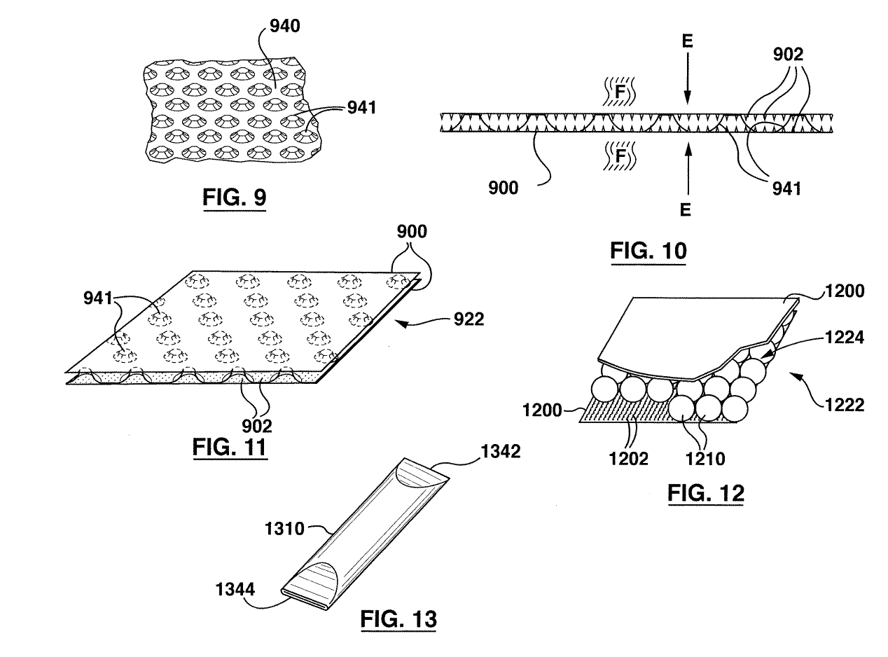

FIG. 9 shows a portion of thin dimpled sheet material 940. Such materials are often designed for use under floors and are available in large rolls. Such materials may be used to form the core of a composite panel, whereby each dimple 941 serves as a core element. Placed between heated skins 900, as shown in FIGS. 10 and 11, and with force E (e.g. light force), barbs 902 of the skins 900 penetrate the material 940 to create a composite panel 922.

FIG. 12 shows another composite panel 1222 in which the core includes multiple hollow spheres as core elements 1210. The hollow sphere core elements 1210 are sandwiched between skins 1200 and penetrated by barbs 1202 of the skins 1200.

FIG. 13 shows a tubular core element 1310 in which opposed ends 1342, 1344 (i.e. first and second ends) of the core element 1310 are sealed. Such sealing can, for example, prevent ingress of unwanted materials and provide buoyancy. In alternative examples, one or both of the first end 1342 and the second end 1344 may be open, so that the cavity is open to the environment at the first end 1342 and/or the second end 1344.

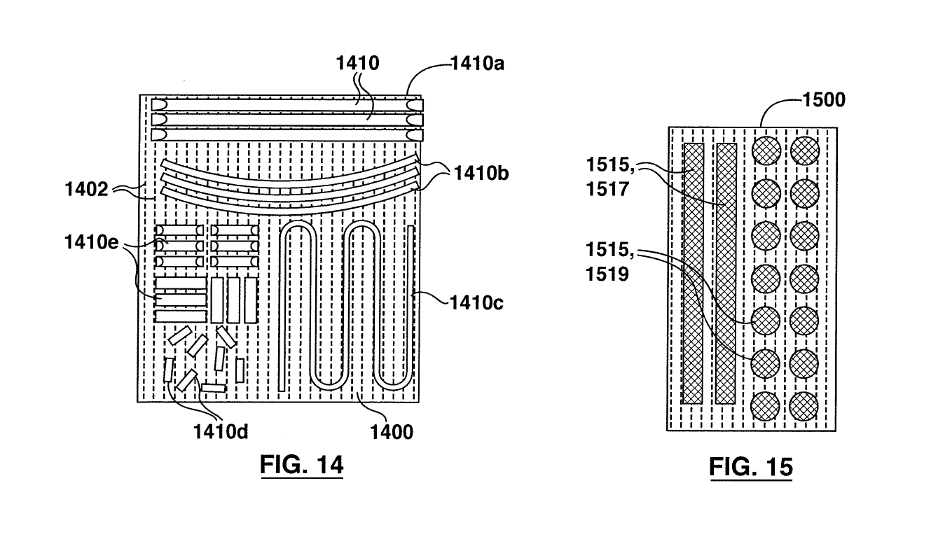

FIG. 14 shows schematically how a variety of core elements 1410 may be arranged on a skin 1400 and penetrated by barbs 1402 thereof. Long sealed end tubular core elements 1410a and curved tubular core elements 1410b can be arranged side-by-side, as a serpentine 1410c, using random pieces 1410d, and in patterns using short lengths 1410e.

FIG. 15 shows an auxiliary material 1515, similar to the material of FIG. 4D, such as thermoplastic sheeting, fabric, film, glass carbon fibre, or mesh etc. The auxiliary material 1515 may be used to augment anchoring of the barbs of the skin 1500 and the core (not shown). Strips 1517 of auxiliary material 1515 may be used with tube shaped core elements, and patches 1519 may be used with spherical core elements.

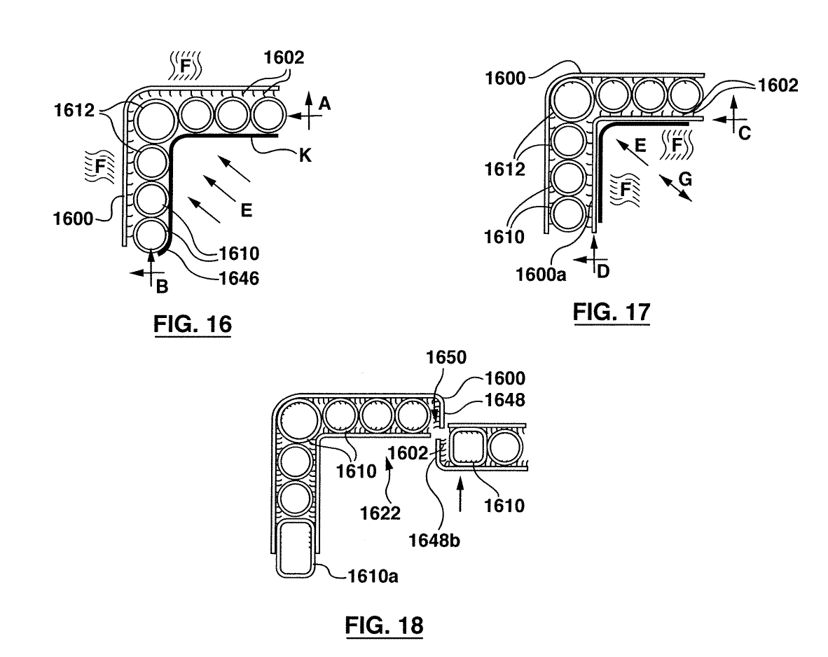

FIGS. 16-19 illustrate how corners and other shaped composite panels 1622, 1623 can be fabricated. FIG. 16 shows a pre-bent outer skin 1600 with tubular core elements 1610 positioned adjacent thereto. A cold plate K is positioned beside the core elements 1610. Using heat F to heat the outer skin 1600 and pressure E on cold plate K, core elements 1610 move towards skin 1600 (arrows A, B). Due to the direction of the force, the hot barbs 1602 melt a skewed path into the shell 1612 of the core elements 1610 as force E on cold plate K moves the core elements 1610 into place.

In FIG. 17, using heat F and pressure E, hot pressure plate K pushes an inner skin 1600a, having barbs 1602 on its inner face, against the shells 1612 of the core elements 1610, also resulting in a skewed melting path (arrows C, D) of the heated inner skin's barbs 1602 through the now stationary shells 1612 of the core elements 1610.

For such skewed motion some oscillation G of the pressure plate K may optionally be used to help urge the barbs 1602 through the molten thermoplastic, as depicted in FIG. 17. As well, pressure plate E may optionally have a flange 1646, as shown in FIG. 16, to facilitate a tight relationship between the core elements.

Such skewed barb travel is also illustrated in FIGS. 20 and 21, where the collated core elements 2010 are too wide (FIG. 20) to fit between the curved end walls of the skin 2000, until the hot barbs 2002 melt into them such that they slide laterally and vertically into position (FIG. 21).

FIG. 18 illustrates a treatment for the ends of the composite panel 1622 (right end) where an overhanging portion of one skin 1600 on adjacent panels is bent into a flange 1648 with a gap 1650 sufficient for the like flange 1648b of the adjacent panel to enter (arrow). The intertwined barbs in the gap 1650 along with adhesive (not shown) can provide a sealed and secure joint. Another approach to joining composite panels such as panel 1622 is to use an elongated core element 1610 (bottom left end of FIG. 18) to provide an attachment point to adjacent structures. Such an elongate core element may also be solid (i.e. not hollow).

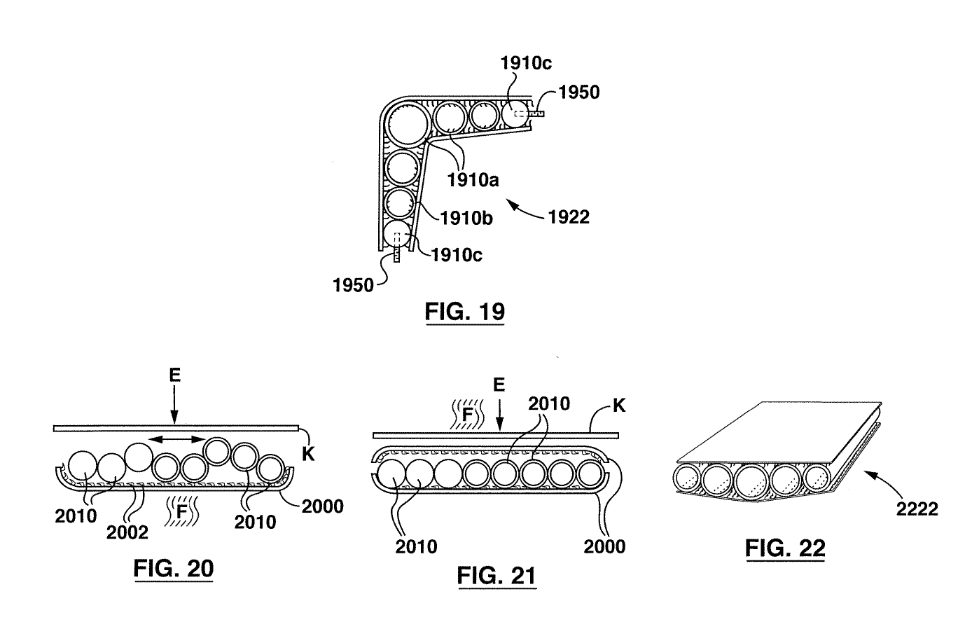

FIG. 19 shows how tubular core elements 1910a and/or spherical core elements 1910b of different diameters can be used to effect a taper to a bent or cornered composite panel 1922. Similarly, FIG. 22 shows effecting a taper in a generally flat composite panel 2222. Such tapered composite panels may have additional strength at the centre while adding minimal weight. Also shown in FIG. 19 is how solid core elements 1910c can be used for example at the panel ends to receive fasteners 1950 (such as studs, nuts, inserts, through holes, locks, latches, weldments, and the like) for connection to adjacent structures including adjacent composite panels.

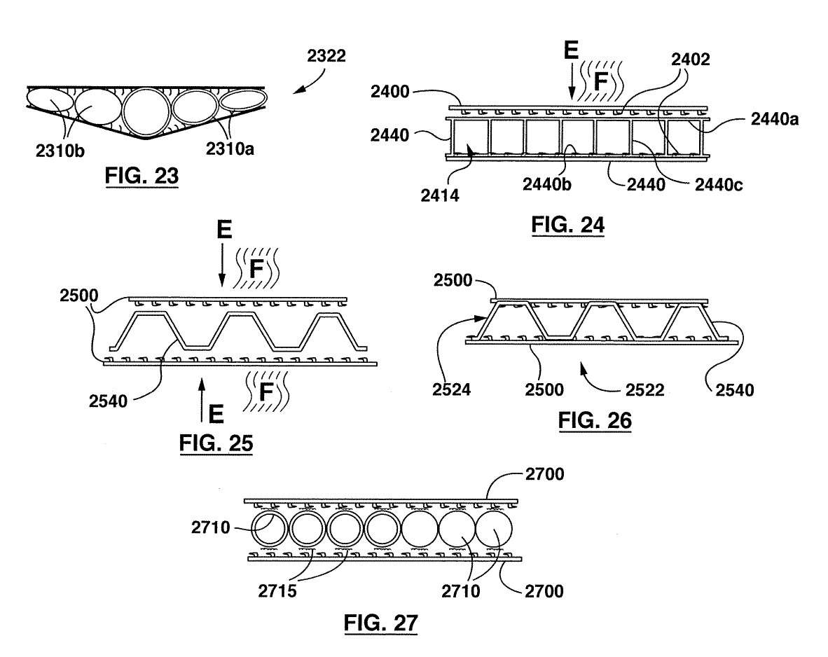

FIG. 23 shows another tapered composite panel 2322 where ovalized tubular core elements 2310a or flattened spherical core elements 2310b form the core.

FIG. 24 shows the formation of a composite panel in which a corrugated plastic (e.g. copolymer resin) sheet 2440 forms the core. Such corrugated plastic sheets are commonly known by the trade name Coroplast™. In some examples, such corrugated sheets may include two flat outer sections 2440a, 2440b, formed as one piece with vertical channel walls 2440c between. In this example, each section of the sheet 2440 that defines a separate cavity 2414 may be considered as a core element. Corrugated plastic sheets may be formed from thermoplastic materials, and skins 2400 with barbs 2402 can be added by the methods previously described herein.

FIGS. 25 and 26 show another example composite panel 2522 in which the core 2524 includes a corrugate sheet 2540, sandwiched between skins 2500 and joined with heat F and pressure E. Each peak or each trough of the corrugate 2520 may be considered as a separate core element.

FIG. 27 shows another example composite panel during formation, and illustrates how auxiliary material 2715, such as small amounts of auxiliary material, can be pre-assembled with the skins 2700 and/or to the core elements 2710, so as to meld into and strengthen the melt zone.

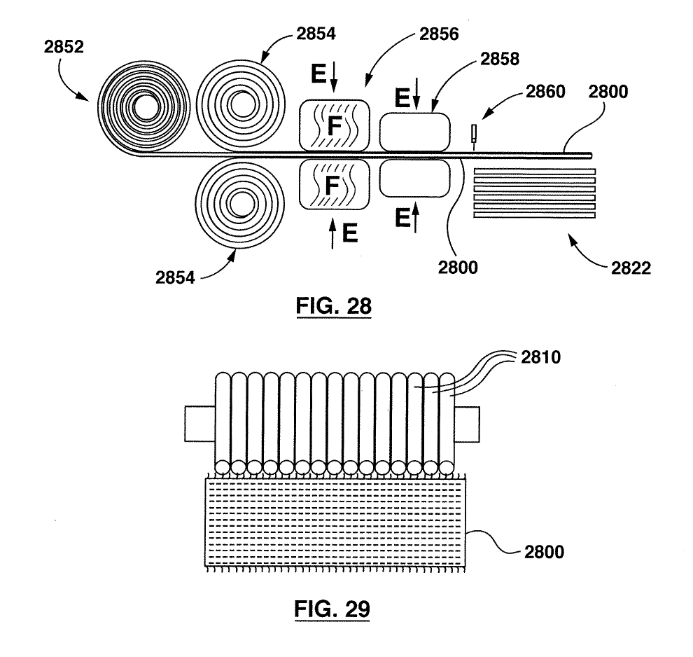

FIGS. 28 and 29 show examples of how a composite panel can be made in a continuous process from coils of skin 2800 (shown in FIG. 29) and core material. The core is made from tubular core elements 2810 (shown in FIG. 29) fed from coil 2852. In alternative examples, the core may be made from other core elements, such as foam, dimple sheet, corrugate, etc., fed from a coil. The skins 2800 may be made from textured sheet material and be fed from coils 2854. The skin material and core element material is fed into a tapered opening of a steel belt press such that at station 2856. Heat F and pressure E are applied to the top and bottom skins, securing them to the core elements as previously described. At station 2858 there is no heat F but pressure E is maintained, resulting in the skins cooling while the barbs remain fully embedded in the shell of the core elements. Station 2860 cuts finished panels 2822 to length.

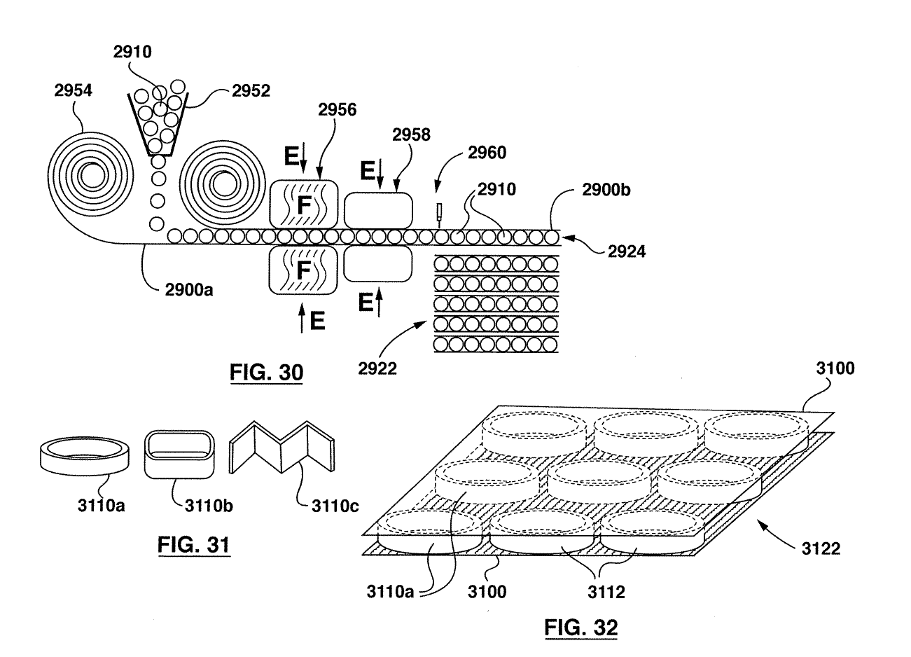

A similar process is shown in FIG. 30, where the core 2924 is made from core elements 2910 that include multiple hollow spheres dropped from a hopper 2952 onto lower skin 2900a fed from coil 2954, where the upper skin 2900b traps the spheres. As in FIG. 28, heating station 2956 applies pressure E, and the composite panel passes through cooling station 2958 where pressure E is maintained. Also as in FIG. 28, cutting station 2960 severs the continuously produced composite panel into panels 2922 of finished length.

FIG. 31 shows some example shapes of core elements 3110a, 3130b, 3110c that can be used in an “edge-way” or “on edge” alignment. Such core elements may be generally stiff and made from a thermoplastic material. Any of core elements 3110a, 3130b, 3110c (or any combination thereof) may be placed on edge between skins so that they are sandwiched by the skins. The skins may then be heated (separately or simultaneously) and pressure applied to cause the barbs of the skins to melt their way into and penetrate the edge or rim or end surfaces of the core elements 3110a, 3130b, 3110c. FIG. 32 shows a phantom view of composite panel 3122 comprising upper and lower skins 3100 sandwiching an array of short lengths of tubular core elements 3110a on edge. As per the preceding description, the barbs of the skins 3100 have become locked into the shell 3112 of the tubular core elements 3110a. This may yield a light, stiff, and economical campsite panel.

While the above description provides examples of one or more processes or apparatuses, it will be appreciated that other processes or apparatuses may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A composite panel comprising:
a) a core comprising a plurality of core elements, each core element being hollow and comprising a respective shell defining a cavity, each shell comprising a thermoplastic material;
b) a pair of skins sandwiching the core, each skin comprising a first face facing away from the core and an opposed second face facing the core, the second face having a plurality of barbs extending therefrom, the barbs penetrating the shells to secure the core elements between the skins.

2. The composite panel of claim 1, wherein each barb has a tip, and at least some of the barbs extend through the shells so that the tips are within at least one of the cavities.

3. The composite panel of claim 2, wherein at least some of the tips are clinched.

4. The composite panel of claim 1, wherein each core element consists essentially of the thermoplastic material.

5. The composite panel of claim 1, wherein each skin comprises a respective metal sheet.

6. The composite panel of claim 1, wherein at least one of the shells is an elongate member having a first end and a second end, and wherein the cavity of the one of the shells is open at the first end and the second end.

7. The composite panel of claim 1, wherein at least one of the core elements is tubular.

8. The composite panel of claim 1, wherein the core comprises a plurality of tubular core elements.

9. The composite panel of claim 1, wherein the core comprises at least one of a corrugated sheet and a dimpled sheet.

10. The composite panel of claim 1, wherein at least one of the cavities is open to the environment.

11. The composite panel of claim 1, further comprising a filler in at least some of the cavities.

12. A method for making a composite panel, comprising:
a) positioning a core element against a barbed face of a first skin, the core element being hollow and comprising a shell defining a cavity, wherein the shell comprises a thermoplastic material;
b) pressing the core element and first skin together to force barbs of the barbed face to penetrate the shell; and
c) prior to or during step b), applying heat to the shell to soften the shell.

13. The method of claim 12, wherein heat is applied to the shell during step b).

14. The method of claim 12, further comprising heating the first skin, wherein heat is applied to the shell via the first skin.

15. The method of claim 12, further comprising, after step b), cooling the shell to harden the shell and securely embed the barbs in the shell.

16. The method of claim 12, further comprising:
a) positioning the core element against a barbed face of a second skin;
b) pressing the core element and the second skin together to force barbs of the barbed face of the second skin to penetrate the shell.

17. The method of claim 12, wherein step b) comprises pressing the core element and first skin together so that tips of at least some of the barbs pass through the shell and into the cavity.

18. The method of claim 17, further comprising clinching the tips.

19. The method of claim 18, wherein clinching the tips comprises passing a plug into the cavity and contacting the tips with the plug to bend the tips.

20. The method of claim 12, further comprising filling the cavity with a filler.
